(19) United States
(12) Patent Application Publication
(10) Pub. No.: US 2013/0047507 A1
(43) Pub. Date: Feb. 28, 2013

(54) SELF-WATERING ELEVATED GROWING SYSTEM

(71) Applicant: David E. TINAPPLE, Powell, OH (US)

(72) Inventor: David E. TINAPPLE, Powell, OH (US)

(21) Appl. No.: 13/417,423

(22) Filed: Mar. 12, 2012

Related U.S. Application Data
(60) Provisional application No. 61/451,846, filed on Mar. 11, 2011.

(51) Int. Cl. A01G 27/06; A01G 9/02

(52) U.S. Cl. 47/81

(57) ABSTRACT

An arrangement for growing plants has a first plant growth container and, optionally, one or more additional plant growth containers. Each plant growth container has a watering reservoir and a growth box, positioned above the watering reservoir, the reservoir and growth box separated by a divider. The watering reservoir is adapted to retain a volume of water therein and the growth box is adapted to retain an amount of a plant growth medium. A wicking device communicates the water to the growth medium. There is also a system for setting and maintaining a constant level of water in the watering reservoir. When additional plant growth containers are present, each watering reservoir is connected with the system for maintaining the constant water level. When the growth boxes of the arrangement are identically sized, they can be arranged in abutting relationship to define a cluster of the plant growth containers.

### CROSS-REFERENCE TO RELATED APPLICATIONS

This application is a non-provisional of, and makes a claim of priority from, U.S. Ser. No. 61/451,846, filed on 11 Mar. 2011, which is incorporated by reference as if fully recited herein.

### TECHNICAL FIELD

The disclosed embodiments of the present invention relate to an arrangement for growing plants in a particulate growth medium that maintains a moisture level of the growth medium during periods of rain or drought. In particular, one or more elevated growth container units are connected with a common watering system.

### BACKGROUND

Horticulture and gardening are some of the earlier industrial arts practiced by humans, but there are still unsolved problems in the arts.

One of the problems is establishing and maintaining a proper level of moisture in an “out of ground” growth medium in which the roots of the vegetables, fruits or flowers are planted. In such an elevated system, maintaining the moisture level of the growth medium is made more acute by the accentuated ability to lose moisture (as in gravity flow out of the medium) and the diminished ability to obtain moisture (as from moisture and ground water in adjacent soil).

It is therefore an unmet advantage of the prior art to provide one or more elevated growth container units, supplied by a common watering system, especially a system that monitors and replenishes the water in an automated manner.

### SUMMARY

This and other unmet advantages are provided by a container for plant growth and an arrangement formed of two or more of the containers. Each container comprises a watering reservoir, a growth box and a wicking means. The watering reservoir has an inlet and an outlet and is adapted to retain a volume of water therein.

The growth box is positioned above the watering reservoir and separated therefrom by a divider. It is adapted to retain an amount of a growth medium, in which plant growth in achieved.

The wicking means communicates the water in the watering reservoir to the growth medium in the growth box by capillary action.

In some of the embodiments, the wicking means comprises a sheet, adapted to be formed into a hollow solid for receiving and retaining a wicking material, particularly when the sheet is adapted to be formed into a cone.

In some of the embodiments, the divider is a plate, seated on a ledge formed inside the growth box. The plate preferably has openings to allow passage of the wicking means therethrough.

In a preferred embodiment, at least the growth box has a trapezoidal profile when viewed from above.

In a preferred embodiment, the arrangement for plant growth has at least one of the plant growth containers and a means for setting and maintaining a constant level of water in the watering reservoir, in liquid communication with the water reservoir.

Even more preferably, this means for setting and maintaining the constant level of water comprises a dispensing reservoir with a flow control valve for maintaining the constant level and a means for liquid communication of the water in the dispensing reservoir to the inlet of the water reservoir, equilibrating the water level in each of the reservoirs. The dispensing reservoir has an outlet, preferably through a wall thereof at a height at or below the level being maintained. In the preferred embodiment, the flow control valve is in the nature of a toilet flush valve.

The arrangement for plant growth preferably has, in addition to the first plant growth container, at least one further plant growth container, as well as a means for liquid communication of the water in the respective water reservoirs, equilibrating the water level in each of the water reservoirs.

Preferably, there are at least two further plant growth containers, and the water reservoirs are connected in series by the liquid communication means. In many of these embodiments, each of the first and the at least one further plant growth containers has a growth box with an identical trapezoidal profile when viewed from above, allowing the respective plant growth containers to be arranged in abutting relationship to define a cluster of the plant growth containers.

### BRIEF DESCRIPTION OF THE DRAWINGS

A better understanding of the disclosed embodiments will be obtained from a reading of the following detailed description and the accompanying drawings wherein identical reference characters refer to identical parts and in which:

FIG. 1 is a perspective view of an embodiment of an elevated plant growth container unit;

FIG. 2 is a top plan view of the FIG. 1 embodiment;

FIG. 3 is a front elevation view of the FIG. 1 embodiment;

FIG. 4 is a right side elevation view; and

FIG. 5 is an exploded perspective view of the FIG. 1 embodiment;

FIGS. 6A through 6G show schematic top plan views of several methods of arranging the FIG. 1 growth container units into growth systems;

FIG. 7 is a perspective photo of a self-watering unit for the FIG. 1 embodiment;

FIG. 8 is a front elevation view of a further aspect of the self-watering unit of FIG. 7;

FIG. 9 is a front perspective view of a second embodiment of elevated plant growth container unit;

FIG. 10 is a side elevation view of the FIG. 9 embodiment, showing further aspects of the unit, including the attachment of a water source;

FIG. 11 is a front elevation view of the FIG. 9 embodiment;

FIGS. 12 and 13 are top plan and front elevation views of the watering reservoir of the FIG. 9 embodiment, isolated from the growth box;

FIGS. 14 and 15 are unassembled plan and assembled sectional elevation views of the wicking cone of the FIG. 9 embodiment;

FIG. 16 is a top plan view of the growth box of the FIG. 9 embodiment;

FIG. 17 is a side sectional view taken along one of the side walls of the growth box of the FIG. 9 embodiment;

FIG. 18 is a perspective view of an unassembled growth container unit of the FIG. 9 embodiment, packaged in a box as a kit; and

FIG. 19 is a top plan view, illustrating the packing of eight of the boxes of FIG. 18 for placement on a pallet.

### DETAILED DESCRIPTION OF A PREFERRED EMBODIMENT

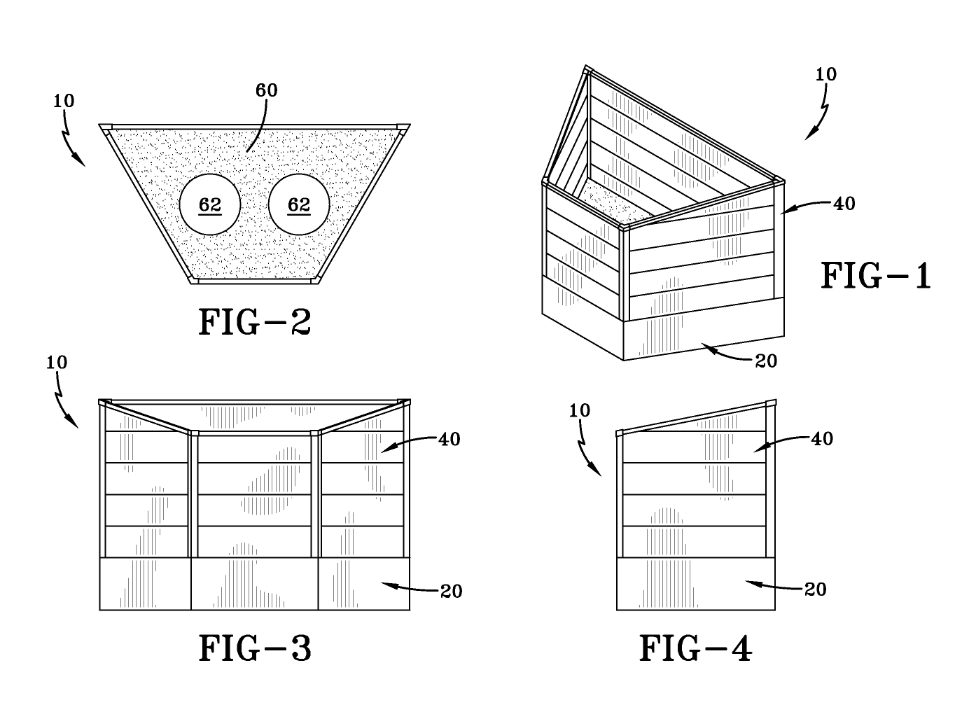

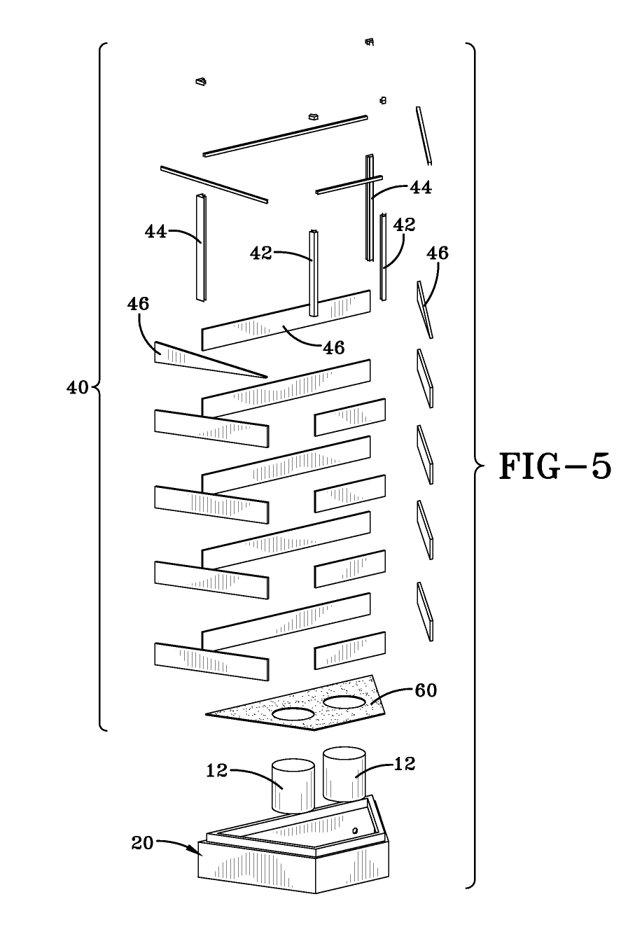

FIG. 1 shows a perspective view of a first embodiment of a single elevated plant growth container unit 10 that may be used, as will be explained later, to provide a network of the units sharing a common watering system. The single growth container unit 10, in this embodiment, comprises a watering reservoir 20 that underlies and supports a growth box 40. A divider plate 60 separates the watering reservoir 20 from the growth box 40. Further aspects of this embodiment of the growth container unit 10 will be also noted in FIGS. 2 through 5, which present top, front, right side and exploded perspective views.

In this embodiment, the growth container unit 10 has a trapezoidal profile when viewed from above. While this particular profile is not critical to the design, and other profiles are clearly useful, it will be seen that significant advantages may be obtained by being able to closely pack individual growth container units in abutting relationship in building up the network. Accordingly, and although a circular profile may provide other advantages, the circular profile is not especially favored in comparison to a plurality of one profile or a collection of two or more profiles that interact with each other to fill the planar space on which they are set out.

The watering reservoir 20 is primarily characterized by providing a chamber with an open top and water-retaining sides and bottom. In some aspects, it may be preferred to use a liner to provide or assure the water retention capability. Generally there will be one or more wall penetrations, located several inches above the bottom of the reservoir. These penetrations permit the water reservoir to be communicated, directly or indirectly, with a water source, and, particularly, with a controlled water source, as will be explained in more detail below. In many cases, the penetrations will also be used to provide a flow conduit for water between a pair of adjacent growth container units 10. And, at least one of the units 10 in a system of the units will use one of the penetrations to provide an overflow drain that allows excess water to be relieved from the system.

The preferred height of the penetrations is in the range of about 50 to 70% of the overall height of the watering reservoir 20, as this provides a buffer of air above the water level, so that rain and other water entering the system do not flood the growth box 40 from below.

It is not required that the water level in the water reservoir 20 be maintained at the top of the water reservoir in order to provide moisture to the growth medium in the growth box 40. A feature of each growth container unit 10 is at least one wicking means 12 that extends vertically from the bottom of the water reservoir at least to the bottom of the growth container unit 10 and preferably into the growth medium present in the growth container unit. One particular embodiment of the wicking means 12 is a column of a sphagnum moss, preferably a column that is maintained in its shape by an open mesh of metal or polymer. Other wicking means, such as cotton batting and polymers having a water-wicking property, are known and may be used instead of the sphagnum moss.

The interface between the water reservoir 20 and the growth box 40 is largely determined by the composition of the divider plate 60. In some embodiments, the divider plate 60 will be effectively non-porous, with an opening 62 corresponding to each of the wicking means 12 that need to transfer water up into the growth box 40. In other embodiments, the divider plate 60 will be an open mesh that allows contact of the wicking means 12 with the growth medium through the openings, although the divider plate would lack any distinct apertures cut into the mesh. In any of the embodiments, a primary feature of the divider plate 60 is a rigidity that suffices to support the growth medium and the plants maintained therein, even when the growth medium is saturated. In some embodiments, this rigidity may be achieved through a frame or lattice of support members. Also, the porosity of the divider plate 60 should be sufficiently low to substantially prevent the growth medium from passing through the divider plate and into the water reservoir 20. In some cases, the porosity may be large enough to allow some plants, such as tomatoes, to send their roots through the divider plate and into the water reservoir 60, resulting in a “hydroponic” type environment for the plants.

Attention is directed now to the growth box 40, the trapezoidal profile of which was already noted. In the depicted embodiment, the growth box 40 comprises four vertical stakes 42, 44, each of which fits into one of the vertices of the trapezoidal-shaped water reservoir 20. In the depicted embodiment, the two front stakes 42 are shorter than the two rear stakes 44, allowing the growth box to be more accessible from the front. A plurality of slats 46 are engaged at their ends in the stakes 42, 44, allowing the overall height of the growth box 40 to vary, depending upon the type of plant being contained. The stakes 42, 44 and the slats 46 can be formed from a variety of materials that will be known to one of ordinary skill, the materials ranging from natural materials such as wood to synthetic materials, especially recycled plastics.

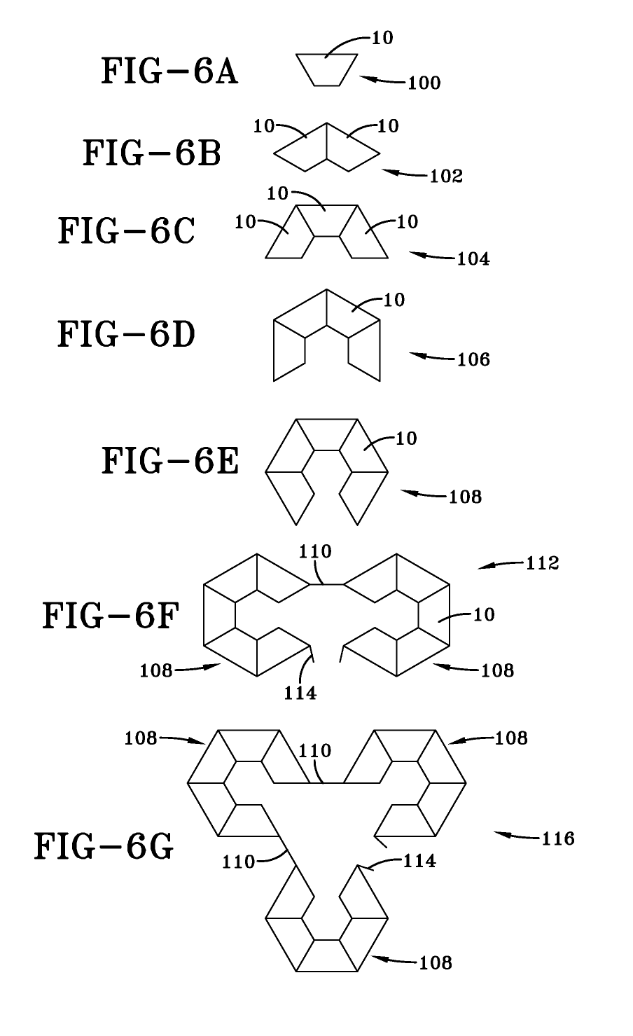

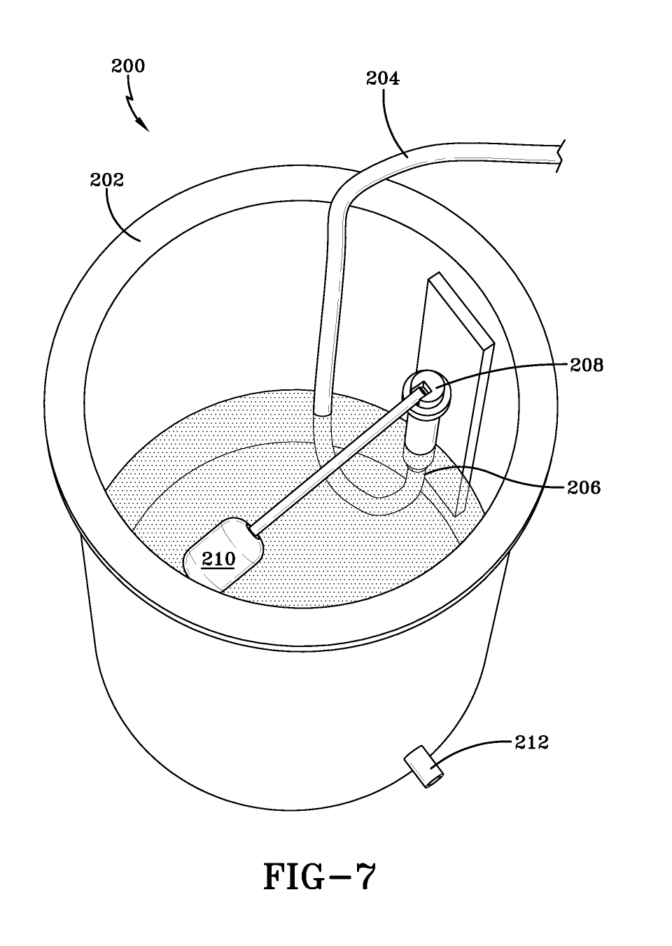

FIGS. 6A through 6G show some of the many arrangements in which the trapezoidal growth container units 10 can be positioned. The trapezoidal profile lends itself to arranging the growth container units into hexagonal shapes. FIG. 6A shows a single unit 100, comprising one growth container unit 10. FIG. 6B shows a double unit 102, in which two units 10 abut along one side edge. FIG. 6C shows a triple unit 104, in which three growth container units 10 used, with one of the units in abutting relationship along two of its side edges with the other two units. FIG. 6D shows four growth container units 10 in abutting relationship to form a quad design 106. FIG. 6E shows five growth container units 10 in a “cluster” arrangement 108, in which the missing sixth unit of the hexagon provides an access to each of the units. By placing two cluster units 108 together and connecting them with a wall unit 110, the double cluster unit 112 is formed, as seen in FIG. 6F, where an optional door 114 is also shown. Placing three cluster units 108 together and using two walls 110 and one door 114, a “triple cluster” arrangement 116 is provided. It will be recognized that, since a cluster unit 108 comprises five growth container units 10, the double cluster 112 has ten such units and the triple cluster 116 provides fifteen. The abutting wall arrangements allow at least all of the growth container units 10 in a cluster 108 to share a common watering system and, in the case of the double or triple cluster, the user can choose to either use a single watering system for the entire arrangement or a single watering system for each cluster. The walls 110 and doors 114 allow the access to the growth container units to be selectively limited. Although the depicted situations show up to fifteen growth container units 10 being used together in the so-called “clusters”, even further variations of this technique are available using the basic building blocks taught herein.

Attention is now directed to FIG. 7, which is a photographic depiction of an embodiment 200 of a watering system that is useful with the growth container units, either singly or in one or more of the FIG. 6 configurations. The watering system 200 is based around a dispensing reservoir 202, to which water is supplied through a standard garden hose 204 that is attached at a first end to a water supply (such as an standard outside spigot). The second end of the 206 of the garden hose 204 is attached to the inlet of a flow control means, in this case, a conventional toilet flush valve 208 with a ball float 210. The flow control means 208 opens when the liquid level in the dispensing reservoir 202 drops below a predetermined level, through the known action of the ball float 210. A hose connection 212, located at or below the predetermined water level, is connected to one of the growth container units (not shown in FIG. 7) by a corresponding hose connection in one of the wall penetrations in the growth container unit. When the dispensing reservoir 202 and the growth container unit are connected in this manner, the water level in each will equilibrate with the other, acting through the conduit of the hose connection 212. As the water in the growth container unit is depleted, the water level in the dispensing reservoir 202 is similarly lowered, opening the flush valve 208 and allowing make-up water to enter through the garden hose 204. Any growth container unit 10 to which the watering system 200 is connected can be connected in turn to one or more growth container units, directly or indirectly, with a common water level being established in each. As mentioned previously, at least one of the growth container units 10 (and preferably all of the growth container units) should be provided with a wall penetration in its water reservoir at a “high level” position to prevent flooding of the growth box 40.

It will be recognized and understood that as rain falls directly on the dispensing reservoir 202 (assuming it has an open top) and on the growth container units 10, this water will be used instead of water from the garden hose 204. This watering method is controlled through the simple action of the flush valve 208, without any monitoring or need for electrical power. The rain water falling on a growth container unit 10 will percolate down through the growing medium. Rain water falling into the dispensing reservoir 202 will flow through to the water reservoir 20 of a growth container unit 10, which will delay the demand for additional water from the dispensing reservoir 202.

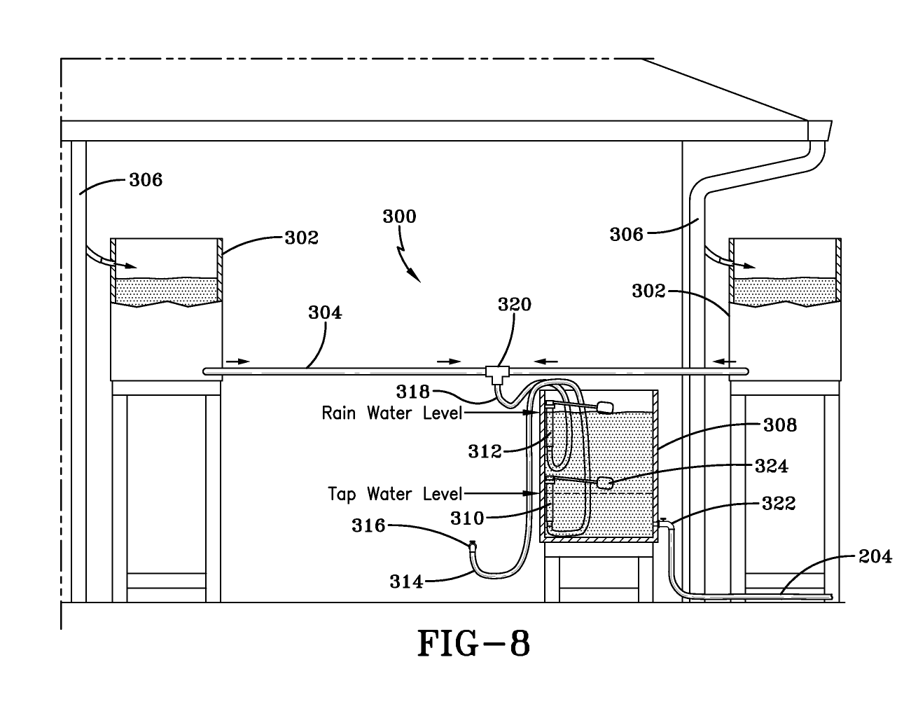

A further extension of the watering system is shown in FIG. 8, where an “upstream” modification of the system is made. In the schematic view of FIG. 8, the garden hose 204 that is shown exiting the system 300 is the same garden hose that has its second end 206 connected in FIG. 7 to the inlet of the flow control means 208. However, as FIG. 8 shows, there is at least one variation on providing the water to the FIG. 7 system only from a pressurized water tap. The system 300 shows two rain water cisterns 302, interconnected by a conduit 304 so that the levels in the cisterns are equilibrated. Each cistern 302 is shown as receiving rain water from a downspout 306. Because conduit 304 is elevated slightly above the bottom of each cistern 302, debris in the rain water (leaves, roofing stone, etc) will settle out in the cistern and not be transferred further downstream. Below the level of the conduit 304 is a make-up water tank 308. Unlike dispensing reservoir 202 of FIG. 7, make-up water tank 308 has two flow control means, denominated as 310 and 312. The first of these, 310, is positioned lower in the tank 308 than the second one 312. Flow control means 310 is connected at its inlet, through a hose 314, to a water supply 316 (such as a standard outside spigot). This is very similar to the situation in the dispensing reservoir 202. Flow control means 312 is connected at its inlet by a hose 318 to a T-joint 320 in conduit 304. In other words, whenever water is present in cisterns 302, the supply water exiting the make-up water tank 308 through hose connection 322 into hose 204 of the FIG. 7 water system will be rain water from the cisterns. Water from the spigot is supplied only when no rain water is available and the level in the make-up water tank 308 drops enough to cause the ball float 324 of flow control means 310 to open. The two levels of flow control are able to operate because flow through hose 204 into the dispensing reservoir is valved at flow control means 208.

The preferred growing medium is a blend of peat, vermiculite and composted materials resulting in a controlled medium which eliminates the uncertainty of the natural soil. The growth container units 10 can be arranged almost anywhere on a flat surface, including yards, patios or roof tops, or even indoors (provided that a proper lighting system is provided).

During winter months the water line is disconnected from the hose bib and the lower drain lines on the reservoir and the container bases are opened. Optional clear plastic covers will prevent the accumulation of unwanted moisture and will serve as cold frames for early planting in spring.

One enters the cluster through a door/gate which could be locked for additional security. Standing in the center of the cluster a slight 60 degree turn moves the gardner from one container to the next. Planting, weeding and harvesting is done standing up. A wood deck in the work area can be built to whatever height suites the height of the user. The largest model, the three cluster unit, has two walled planting areas for growing bulky crops on the ground in the traditional manner such as sweet corn, beans, watermelons, etc.

Because the stakes 42, 44 and the slats enable the sides of the growth box 40 to easily extend, if desired, higher than the plants in the growth medium, the growth box is amenable to being fitted with various covers, including a transparent cover that can convert the growth box into a cold frame for starting plants or a netting cover, to prevent access to fruit of flowers by insects or animals, especially birds.

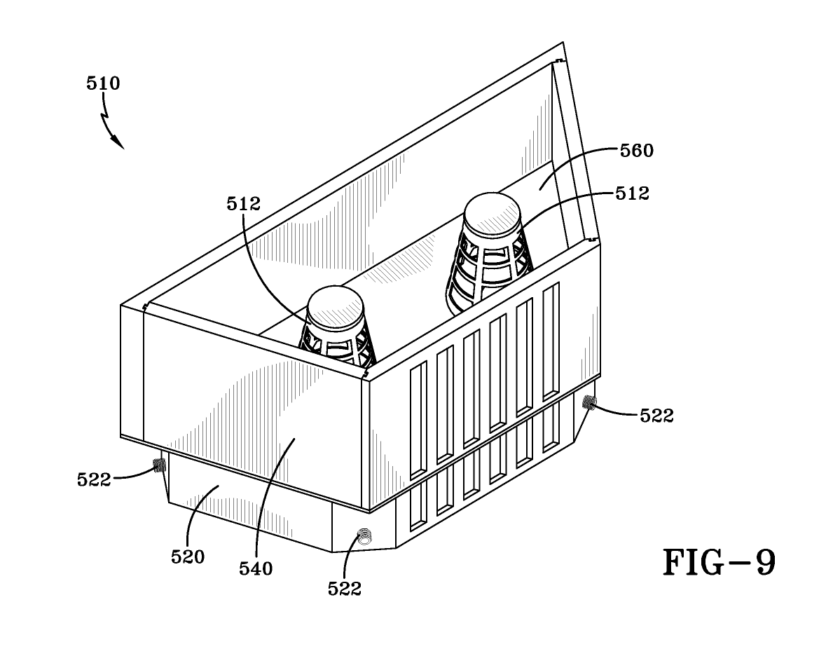

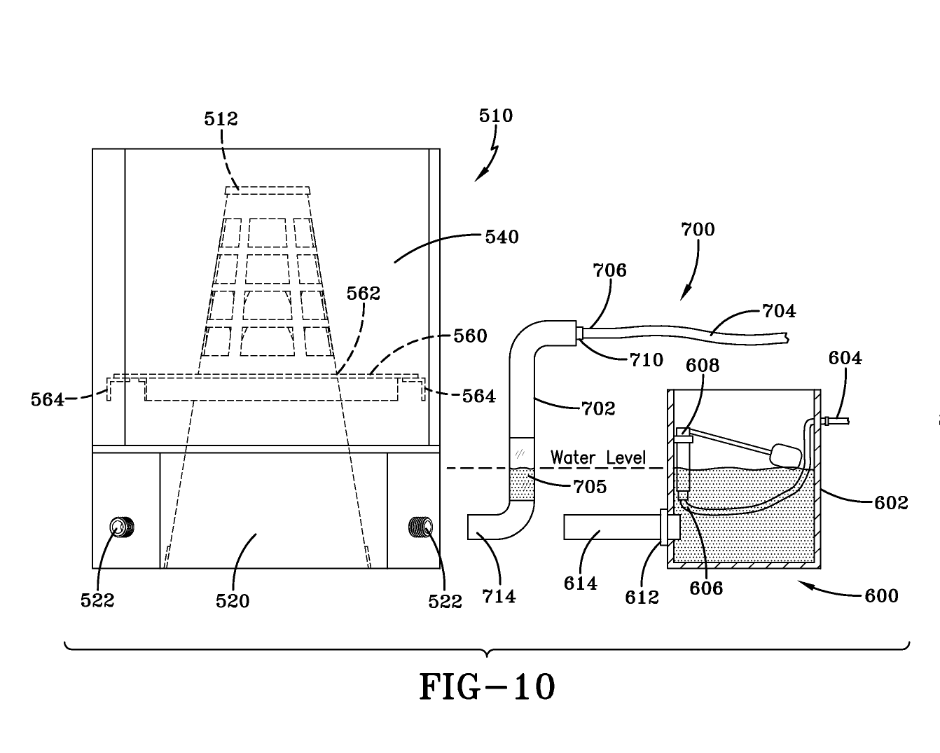

FIG. 9 shows, in perspective view, a second embodiment of a single elevated plant growth container unit 510 that may be used to provide the network of the units sharing a common watering system. The single growth container unit 510, in this embodiment, comprises a watering reservoir 520 that underlies and supports a growth box 540. A divider plate 560 separates the watering reservoir 520 from the growth box 540. Also notable in FIG. 9 are a plurality of inlet/outlet ports 522 in the side walls of the watering reservoir 520 and the wicking means 512, which is depicted as a pair of conical bodies the project from the watering reservoir through the divider plate 560 and into the interior of the growth box 540.

In this embodiment, the growth container unit 510, or more specifically, at least the growth box 540 thereof, has a trapezoidal profile when viewed from above. While this particular profile is not critical to the design, and other profiles are clearly useful, it will be seen that significant advantages may be obtained by being able to closely pack individual growth container units 510 in abutting relationship in building up the network. Accordingly, and although a circular profile may provide other advantages, the circular profile is not especially favored in comparison to a plurality of one profile or a collection of two or more profiles that interact with each other to fill the planar space on which they are set out.

FIG. 10 is a side elevation view of the unit 510, showing details of two methods of connecting the unit to the water supply that fills and replenishes the watering reservoir 520, providing the water to be transported through capillary action in to the growth box 540 by the wicking means 512.

The first method is very similar to that depicted in FIG. 7. The watering system 600 is based around a dispensing reservoir 602, to which water is supplied through a standard garden hose 604 that is attached at a first end to a water supply (such as a standard outside spigot). The second end 606 of the garden hose 604 is attached to the inlet of a flow control means, in this case, a conventional toilet flush valve 608, which is mounted inside the dispensing reservoir 602. The flow control means 608 opens when the liquid level in the dispensing reservoir 602 drops below a predetermined level, through the known conventional action of the flush valve. A hose connection 612, located at or below the predetermined water level, is connected to an inlet/outlet port 522 of the growth container units 510 by a corresponding hose 614 connection. When the dispensing reservoir 602 and the growth container unit 510 are connected in this manner, the water level in each will equilibrate with the other, acting through the conduit of the hose connection 612. As the water in the growth container unit is depleted, the water level in the dispensing reservoir 602 is similarly lowered, opening the flush valve 608 and allowing make-up water to enter through the garden hose 604 from the water source. Any further growth container unit 510 in the network may be connected to the watering system 600. This is preferably accomplished by connecting the first growth unit directly to the watering system and then, using an inlet/outlet port 522 of the first growth unit, connecting the first unit to an inlet/outlet port of the further unit. The units 510 can thus be connected in series, with a common water level being established in each. Obviously, inlet/outlet ports that are not actively used can be capped.

It will be recognized and understood that as rain falls directly on the dispensing reservoir 602 (assuming it has an open top) and on the growth container units 510, this water will be used instead of water from the garden hose 604. This watering method is controlled through the simple action of the flush valve 608, without any monitoring or need for electrical power. The rain water falling on a growth container unit 510 will percolate down through the growing medium. Rain water falling into the dispensing reservoir 602 will flow through to the water reservoir 520 of a growth container unit 510, which will delay the demand for additional water from the dispensing reservoir 602.

The second method depicted in FIG. 10 is a watering system 700, based around a dispensing reservoir 702, which is, in this case, depicted as a simple tube. Water is supplied through a standard garden hose 704 that is attached at a first end to a water supply (such as a standard outside spigot). The second end 706 of the garden hose 704 is attached to a hose inlet fitting 710. In this case, a portion of the dispensing reservoir 702 may be configured as a transparent tube 705, with the predetermined water level falling approximately in the middle of the transparent portion. This manual method allows a user to visually determine that water needs to be added and to provide it by opening the water supply at the spigot. Connection to one or more growth units 510 is accomplished in the same manner as when using the first method, but in this case using hose 714.

It will be recognized and understood that as rain falls directly on the dispensing reservoir 602 (assuming it has an open top) and on the growth container units 510, this water will be used instead of water from the garden hose 604. This watering method is controlled through the simple action of the flush valve 608, without any monitoring or need for electrical power. The rain water falling on a growth container unit 510 will percolate down through the growing medium. Rain water falling into the dispensing reservoir 602 will flow through to the water reservoir 520 of a growth container unit 510, which will delay the demand for additional water from the dispensing reservoir 602.

A few features of the growth box 540 are also observed in FIG. 10. Divider plate 560 is depicted as being supported by flanged bars 564, and the wicking cones 512 extend through openings 562 in the divider plate. The flanged bars 564 form a ledge upon which the divider plate 560 is removably seated.

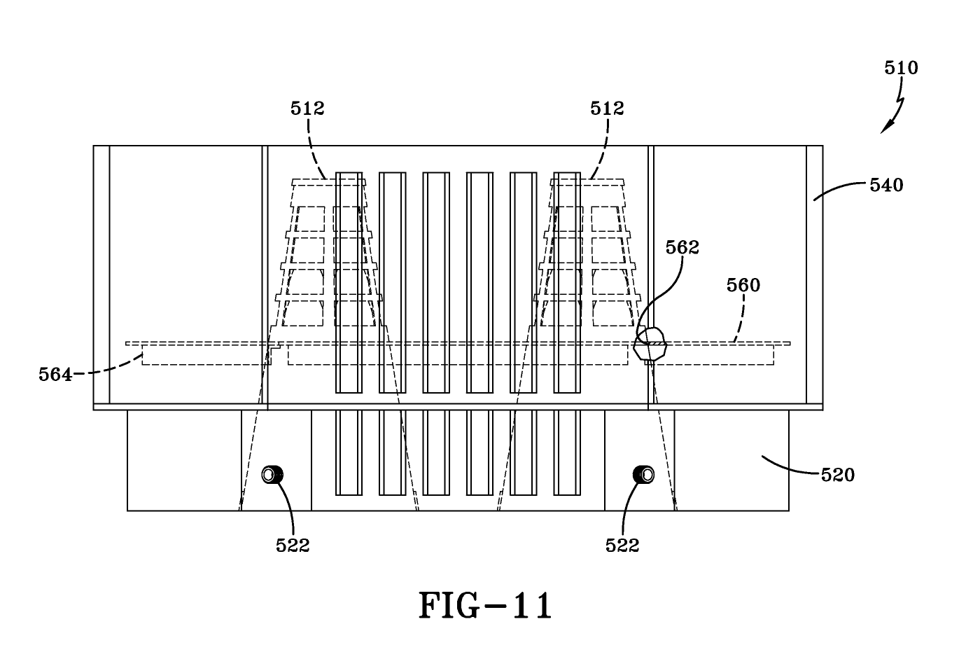

It is also observed that a preferred site for the inlet/outlet ports 522 may be at the corners of the sides of the watering reservoir 520, the corners being foreshortened to accommodate the ports. This positioning of the inlet/outlet ports 522 is also seen in the front elevation view of FIG. 11. Also visible in this view is the placement of the flanged bars 564, which are not located at the bottom of the growth box 540, but are actually intermediate to the height of the side walls. Several part numbers from FIGS. 9 and 10 are shown on FIG. 11 without comment as to the parts. Although two wicking cones 512 are shown, the system is not defined or determined by this number. Similarly, while the preferred wicking means is conical, like wicking cone 512, the wicking means can be another shape, especially right cylindrical.

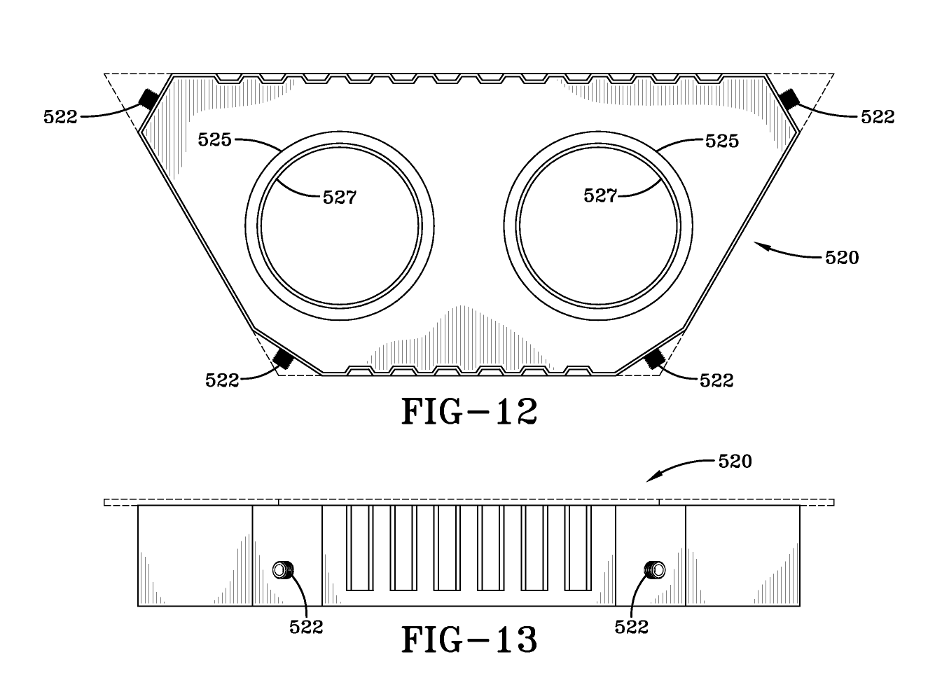

FIGS. 12 and 13 are top plan and front elevation views of the watering reservoir 520 of the FIG. 9 embodiment, isolated from the growth box. The watering reservoir 520 is primarily characterized by providing a chamber with an open top and water-retaining sides and bottom. In some aspects, and unless the watering reservoir 520 is formed in some sort of unitary manner, it may be preferred to use a liner to provide or assure the water retention capability. Generally there will be one or more wall penetrations, provided to receive the inlet/outlet ports 522, which are depicted as having male threading to receive a hose coupling. These penetrations, when provided may be located a various heights along the side walls of the watering reservoir 520. It is very desirable to provide at least one of the watering reservoirs in an assembled system with an inlet/outlet port that is open, so that it operates as an overflow drain to relieve excess water from the system without flooding the growth box from below, particularly in a situation of excessive rain or a failure of the flush valve in the “open” position. For exemplary purposes, a pair of concentric circles 525, 527 in phantom lining show the coverage of the wicking cores at the base of the watering reservoir and at the level of the divider plate, respectively.

The growth system described in this specification does not require, and, strongly discourages, direct contact of the plants being grown, and especially their roots with the water being retained in the water reservoir 20, as the transfer of water into the growth box occurs through the wicking means.

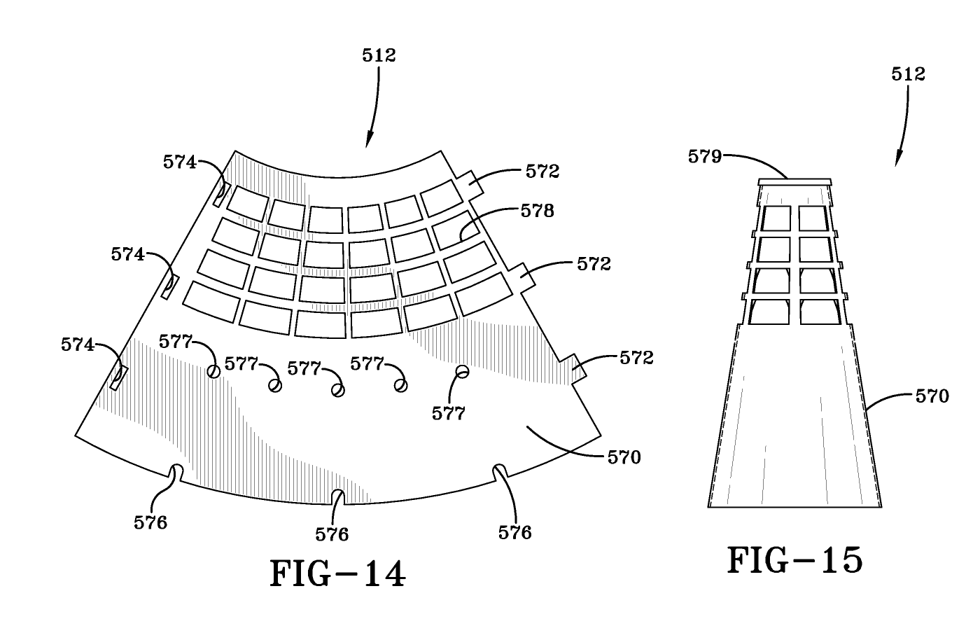

FIGS. 14 and 15 show, in unassembled plan and assembled sectional elevation views, one embodiment of a wicking cone 512 that is intended to receive and contain a mass of a material that can raise water by capillary action from the water reservoir into the growth box, where it is absorbed by the growth medium. The depicted wicking cone 512 is preferably formed from a sheet 570 of polymeric material, having sufficient rigidity to stand independently, even when not filled with the wicking material. To be able to be shipped in an unassembled condition, it would be preferred to be flexible. The depicted embodiment 512 has corresponding joining means shown on the side edges, in the nature of tabs 572 and slots 574. The lower portion of the cone 512 will be provided with means for water to flow relatively unimpeded into the wicking material inside the formed cone, such as bottom openings 576 and lower intermediate openings 577. Towards the upper end of the assembled cone, openings 578 are readily seen to be more numerous and larger in size, facilitating intimate contact between the wicking material and the growth medium in the growth box. While not shown in FIG. 14 and considered optional, a cap 579 is shown in FIG. 15. The cap 579, when used, allows the user to have access to the wicking material, but generally protects it from the environment.

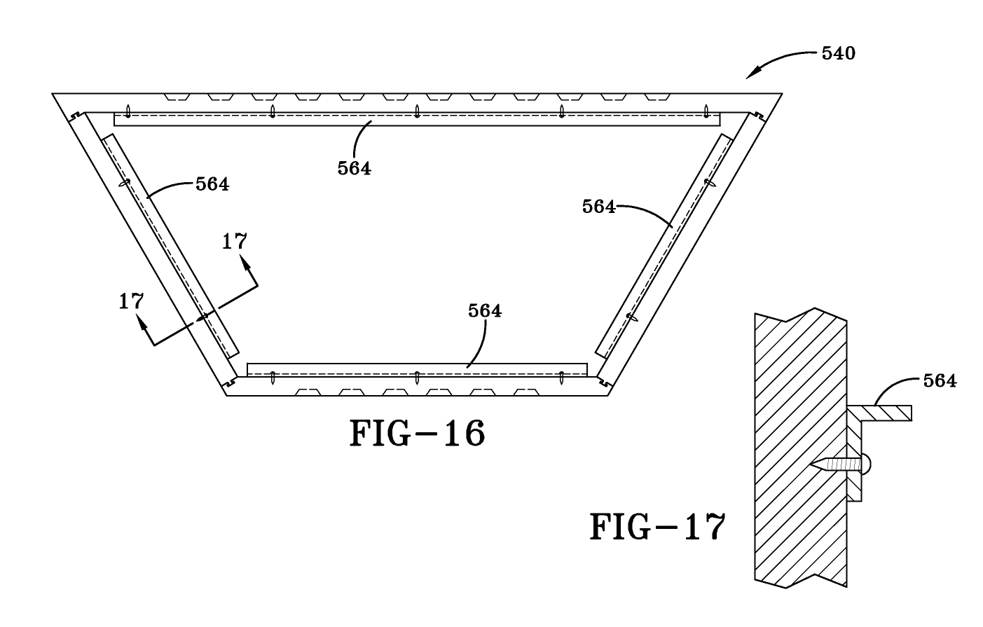

FIG. 16 show details of the growth box 540 of the FIG. 9 embodiment in a top plan view. FIG. 17 is a sectional view taken along through one of the side walls to show details. Unlike the other embodiment growth box 40, this growth box 540 has its trapezoidal profile provided by four walls that are joined along their facing edges. The four walls have substantially the same height in this embodiment 540, as best seen in FIG. 9. Each of the inside surfaces of the walls is provided with the flanged bars 564 that provide a surface on which the divider plate can be seated, although the divider plate is not shown in FIG. 16. The walls comprising the growth box 540 can be formed from a variety of materials that will be known to one of ordinary skill, the materials ranging from natural materials such as wood to synthetic materials, especially recycled plastics.

The interface between the water reservoir 520 and the growth box 540 is largely determined by the composition of the divider plate 560. In some embodiments, the divider plate 560 will be effectively non-porous, with an opening 562 corresponding to each of the wicking means 512 that need to transfer water up into the growth box 540. In any of the embodiments, a primary feature of the divider plate 560 is a rigidity that suffices to support the growth medium and the plants maintained therein, even when the growth medium is saturated with moisture and the plants are full-grown and fruit-laden. In some embodiments, this rigidity may be achieved through a frame or lattice of support members. Also, the porosity of the divider plate 560 should be sufficiently low to substantially prevent the growth medium from passing through the divider plate and into the water reservoir 520. In some cases, the porosity may be large enough to allow some plants, such as tomatoes, to send their roots through the divider plate and into the water reservoir 560, resulting in a “hydroponic” type environment for the plants.

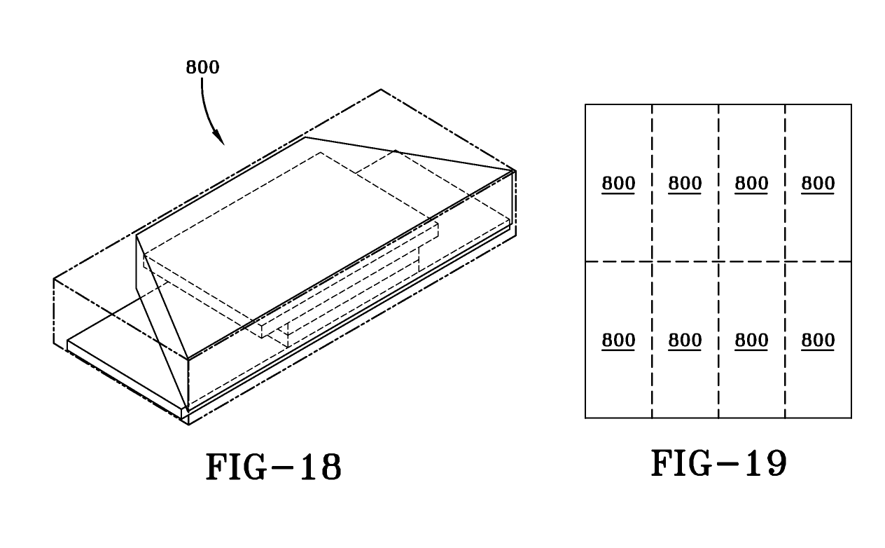

A further advantageous aspect of the growth container unit 510 is the capability of providing it in an unassembled kit for assembly at the point of use. As illustrated in FIG. 18, one specific size of growth container unit 510 can be readily packaged in a box 800 measuring 58 inches by 24 inches by 10 inches. Eight of these boxes can be placed on a standard 48 inch by 40 inch shipping pallet with the 24 inch by 10 inch faces resting on the pallet, as shown in FIG. 19.

What is claimed is:

1. A container for plant growth, comprising:
a watering reservoir, having an inlet and an outlet, the watering reservoir adapted to retain a volume of water;
a growth box, positioned above the watering reservoir and separated therefrom by a divider, the growth box adapted to retain an amount of a growth medium; and
a wicking means, communicating the water in the watering reservoir to the growth medium in the growth box by capillary action.

2. The container of claim 1, wherein:
the wicking means comprises a sheet, adapted to be formed into a hollow solid for receiving and retaining a wicking material.

3. The container of claim 2, wherein:
the sheet is formed into a cone.

4. The container of claim 1, wherein:
the divider is a plate, seated on a ledge formed inside the growth box, the plate having openings to allow passage of the wicking means therethrough.

5. The container of claim 1, wherein:
at least the growth box has a trapezoidal profile when viewed from above.

6. An arrangement for plant growth, comprising:
a first plant growth container of claim 1; and
a means for setting and maintaining a constant level of water in the watering reservoir, in liquid communication with the water reservoir.

7. The arrangement of claim 6, wherein:
the means for setting and maintaining the constant level of water comprises:
a dispensing reservoir, having an outlet located through a wall thereof at a height at or below the level being maintained;
a flow control valve, arranged in the dispensing reservoir to maintain a water level in the dispensing reservoir;
means for liquid communication of an inlet of the flow control valve to a water supply; and
means for liquid communication of the water in the dispensing reservoir to the inlet of the water reservoir, equilibrating the water level in each of the reservoirs.

8. The arrangement of claim 7, wherein:
the flow control valve is a toilet flush valve.

9. The arrangement of claim 6, further comprising:
at least one further plant growth container of claim 1; and
means for liquid communication of the water in the water reservoir of the first plant growth container to the water in the water reservoir of each of the further plant growth containers, equilibrating the water level in each of the water reservoirs.

10. The arrangement of claim 9, wherein:
there are at least two further plant growth containers, and the water reservoirs are connected in series by the liquid communication means.

11. The arrangement of claim 9, wherein:
each of the first and the at least one further plant growth containers has a growth box with an identical trapezoidal profile when viewed from above.

12. The arrangement of claim 11, wherein:
there are at least two further plant growth containers, and the water reservoirs are connected in series by the liquid communication means.

13. The arrangement of claim 11, wherein:
each of the first and the at least one further plant growth containers are arranged in abutting relationship to define a cluster of the plant growth containers.

14. The arrangement of claim 13, wherein:
there are at least two further plant growth containers, and the water reservoirs are connected in series by the liquid communication means.

15. The arrangement of claim 14, wherein:
the means for setting and maintaining the constant level of water comprises:
a dispensing reservoir, having an outlet located through a wall thereof at a height at or below the level being maintained;
a flow control valve, arranged in the dispensing reservoir to maintain a water level in the dispensing reservoir;
means for liquid communication of an inlet of the flow control valve to a water supply; and
means for liquid communication of the water in the dispensing reservoir to the inlet of the water reservoir, equilibrating the water level in each of the reservoirs.

16. The arrangement of claim 15, wherein:
the flow control valve is a toilet flush valve.
